(19) United States
(12) Patent Application Publication
(10) Pub. No.: US 2008/0023173 A1
(43) Pub. Date: Jan. 31, 2008

(54) FAN SHROUD FOR AUTOMOTIVE APPLICATIONS

(75) Inventor: John R. Savage, Rochester Hills, MI (US)

Correspondence Address: MATTHEW R. JENKINS, ESQ., 2310 FAR HILLS BUILDING, DAYTON, OH, 45419, US

(73) Assignee: VALEO, INC., Rochester Hills, MI (US)

(21) Appl. No.: 11/610,692

(22) Filed: Dec. 14, 2006

Related U.S. Application Data
(60) Provisional application No. 60/834,380, filed on Jul. 31, 2006.

(51) Int. Cl. B60H 1/32

(52) U.S. Cl. 165/41

(57) ABSTRACT

A heat exchange system and method for use with a combo-cooler heat exchanger as shown. In one embodiment, a combination of a heat exchanger module with a combo-cooler heat exchanger and a fan shroud is disclosed wherein the fan shroud covers approximately one-hundred percent of the condenser of the combo-cooler heat exchanger and leaves portions of the fluid coolers of the combo-cooler open to ram airflow.

### CROSS-REFERENCE TO RELATED APPLICATION

This application claims the benefit of U.S. provisional application Ser. No. 60/834,380, filed Jul. 31, 2006, which is incorporated herein by reference and made a part hereof.

### BACKGROUND OF THE INVENTION

1. Field of the Invention

This invention relates to fan shrouds designed to hold cooling fans in automotive applications, such as automotive front end heat exchanger modules, are described.

2. Description of the Related Art

Front end heat exchanger cooling modules typically have a radiator (e.g. providing cooling utilizing engine coolant), a condenser (e.g., providing cooling for cabin HVAC systems), and often have auxiliary air to oil coolers used to provide cooling for transmission and power steering fluid or for engine oil. These auxiliary air to oil coolers are typically installed in front of the condenser. The fan content is usually installed on the downstream side of the radiator core face. Typical configurations for existing heat exchanger modules are identified in the figures herein below.

Cooling fans are needed to provide adequate airflow through the heat exchangers to maintain coolant and fluid temperatures within prescribed limits to maintain proper function of vehicle power train and cabin HVAC components for all vehicle operating conditions. Cooling fans provide 100% of the airflow at idle conditions and combine with ram airflow, which is generally caused by movement of a vehicle, to meet cooling airflow demands for moving vehicle operating conditions. Cooling fans are typically positioned on the back side of the heat exchanger module, but can be installed on the front side as well.

Fixed shrouding is often used with the cooling fan to enhance cooling airflow pulled through the heat exchangers for idle operation and for vehicle operating speeds where the fan can provide more flow through the heat exchangers than ram airflow coming through the grille is capable to do. FIG. 1 shows a typical prior art module configuration with a 100% coverage area fan shroud configuration. For ease of illustration, FIGS. 1-5 refer to a radiator R, condenser C, transmission cooler TC and power steering cooler PS.

A typical module configuration shows the fan shroud covering 100% of the Radiator area and also covers 100% of the condenser, transmission, and power steering oil cooler.

Fan systems with 100% coverage of cooling module flow area often have issues with airflow performance at higher vehicle speeds. This is particularly true for electric motor driven fan systems. Electrical power available for the fan system is often limited. Ram airflow at vehicle speeds as low as 45 MPH often overpowers the capability for the electric fan system to draw cooling airflow through the heat exchanger module. In these cases, total airflow through the heat exchanger module would increase if the electric fan system were physically removed from the vehicle. The case where ram flow offers more flow potential than the fan system is usually associated with electric fan systems. Engine driven fan systems usually have access to adequate power from the engine to allow fan provided airflow to always have more potential to draw flow through the heat exchangers than the potential of ram airflow.

Fan shroud designs for electric fan systems where the ram flow overpowers the capability of the fan to draw flow through the heat exchangers have relied on several different means to increase airflow at higher vehicle operating speed conditions including: partial shroud coverage area; bypass flaps, or ram air bypass holes. All these solutions present problems in one way or another.

Partial coverage shroud area configurations, for example, often allow higher velocity ram flow to pass through the open heat exchanger area (see the left side of the front view of prior art shown in FIGS. 2 and 3, for example). This increases flow for higher vehicle speed conditions, but reduces flow through the condenser at idle conditions negatively impacting condensing and A/C system performance at idle conditions. Idle A/C performance and corresponding idle airflow through the condenser is often a worst case design point for the cooling fan system. Any additional loss in condensing performance is not desired.

Bypass flaps are also used to improve heat exchanger airflow for higher vehicle speed conditions. Illustrative flaps are shown in the prior art shown in FIG. 4. Bypass flaps are essentially 1-way “flaps” or “flapper valves” placed on the back wall of the shroud that open when ram flow exceeds the potential for the fan to draw flow through the heat exchangers. The flaps close at idle to allow the fan to pull 100% of its flow through the heat exchangers.

Though flaps do improve airflow at higher vehicle speeds while maintaining airflow at idle conditions, typically, the centerline of the fan needs to be shifted to one side to create enough room on the back wall of the shroud to accommodate the flaps. This offset reduces shroud effectiveness and results in lower idle airflow than what would occur for a fan centered in the radiator core face area. In addition, the airflow at higher vehicle speeds with the flap configuration is not as much as would be achieved for a partial coverage shroud configuration with open area matching the flap area. Ram flow energy (or pressure) is expended to open the flap that results in less total flow. In addition, flaps add an extra part and associated part number, add cost, and increase assembly labor.

Ram air bypass holes, such as in the prior art configuration shown in FIG. 5, are similar to the flap configuration shown in FIG. 4, but leave the holes normally opened or closed by the flaps open. Extensions may be positioned along the perimeter of the open area in the back wall of the shroud to reduce the amount of flow that the fan moves that has not passed through the heat exchangers. These improve airflow at higher vehicle speeds, but cause an issue at idle. Fan pulls air from the engine compartment through the open bypass hole which reduces total useful flow thru the heat exchanger. Examples of ram bypass holes are shown in the FIGS. 4 and 5.

One problem that still remains is how to maximize airflow for higher vehicle operating speeds while maintaining adequate idle airflow to satisfy condensing needs for the A/C system.

### SUMMARY OF THE INVENTION

There is, therefore, one object of the invention is to provide maximum airflow for higher operating speeds while maintaining adequate idle airflow to a condenser for the air conditioning system.

Aspects of the present invention relate to shrouds, and, in particular, cooling fan shrouds for automotive applications. In various aspects of the present invention, the design of cooling fan shrouds is used for automotive front end heat exchanger modules. Heat exchanger modules, that is, heat exchanger assemblies not including fan elements and/or front end module elements not related to fluid circulation are often used to provide cooling for automotive vehicles, including vehicle power train and air conditioning (A/C) systems.

Various aspects of the present invention solve at least one problem that still remains—how to maximize airflow for higher vehicle operating speeds while maintaining adequate idle airflow to satisfy condensing needs for the A/C system.

In various aspects of the present invention, a fan shroud (when used in automotive cooling applications hereinto referred to as a “cooling fan shroud”) is designed that provides or allows for higher airflow to be achieved through the radiator and oil cooler heat exchangers for higher vehicle operating speeds; this higher airflow is higher than those currently achieved using current art fan shrouds. Any measurable improvement in airflow is of benefit. The amount of increased airflow of the partial coverage shroud design is driven by combinations of independent variables such as: specific areas of covered and non-covered heat exchanger surface area, meter per second value of vehicle ram flow, fan power level, vehicle speeds, heat exchanger pressure restriction levels, etc. The cooling fan shroud designs, in accordance with aspects of the present invention, when used in conjunction with condenser related applications, actually increases condenser airflow for idle operation, without adding cost to the overall system.

For example, an engine cooling fan shrouding that has open areas to allow increased ram flow through oil cooler portions of a combo condenser/oil cooler heat exchanger can be found in one aspect of the present invention.

One embodiment of the present invention, in various aspects, can be used with a variety of cooler modules. In some of the embodiments of these aspects, a combo-cooler design (design wherein tubes share a common set of manifolds) (see, for example, US Patent Application No. US2003-0209344A1, published on Nov. 13, 2003, incorporated herein by reference and made a part hereof), is used for the heat exchanger. In heat exchanger assemblies comprising a fan cooling module, a combo-cooler design heat exchanger is used in combination with a partial coverage shroud design. By partial coverage shroud design, one meaning is that the shroud covers less than 100% of the frontal area established by the perimeter of the airflow area of the heat exchangers. A heat exchanger assembly comprising a fan cooling module and heat exchanger, and, particularly, a combo-cooler design heat exchanger, combines the benefits and cost savings of a combo-cooler design along with a partial coverage shroud design. In combo-cooler design heat exchangers comprising an oil cooler portion and a condenser portion, the partial coverage shroud allows ram airflow full and/or virtually unimpeded access to areas of the oil cooler portion of the combo-cooler, as well as a radiator, where present, to higher levels of ram airflow at higher vehicle speeds while maintaining 100% coverage of the condenser portion of the combo-cooler heat exchanger face area.

In various aspects of the present invention, the combo-cooler design heat exchanger has a core comprising tubes. A portion of the core comprising tubes functions as an oil cooling portion, and a portion of the core comprising tubes functions as a condenser portion. In combo-cooler heat exchangers, at least one part of the heat exchanger, therefore, is generally devoted to A/C Condenser related functions, and at least one other part is generally devoted to oil cooling functions. One illustrative combo-cooler system is shown in U.S. Pat. No. 6,793,012, which is incorporated herein by reference and made a part hereof. By oil, it is meant to include any automotive fluid with oil characteristics, such as transmission fluid, power steering fluid, or engine oil.

This configuration allows cooling flow to be maximized through the radiator and oil cooler portions of the combo-cooler for grade trailer tow requirements, while maintaining or improving airflow though the condenser for Idle operating conditions.

This maximizes airflow at higher speed trailer grade operating conditions while actually increasing idle airflow through the condenser portion.

Aspects of the present invention, therefore, have the advantage of the combo-cooler design along with the advantage of a unique fan shroud configuration. The overall combination of combo-cooler heat exchanger and cooling fan shroud design is particularly useful in light truck and SUV market segments where high speed trailer tow requirements are often a worst case cooling system design consideration. These aspects provide both a cost and a performance advantage formerly not seen in other heat exchanger assemblies. The cooling fan shroud, though providing a competitive advantage in and of itself in automotive applications, its use in combination with a specific heat exchanger design, provides heretofore unforeseen advantages when used with various combo-cooler heat exchanger designs.

Illustrated aspects of the present invention provide for a combo-cooler design or type heat exchanger having a cooling fan shroud, wherein the shroud substantially covers the condenser. For example, under various conditions, it might be best for idle operation to cover 100% of the condenser, but there could be times where covering less than 100% of the condenser is desired by specification to improve high speed cooling, even at some expense to maximizing idle condenser performance. About 100%, of the condenser tube face area of the condenser core portion of the combo-cooler design heat exchanger for example, can be covered, leaving portions of the oil cooler tube area of the combo-cooler design heat exchanger open to or subjected to ram flow.

In various embodiments of the present invention, though portions of the oil cooler tube area of the combo cooler are ‘blocked’ or unavailable to cooling airflow at idle conditions, at least a portion of the oil cooler tubes (a significant portion of the oil cooler tube area) receive or are capable of receiving fan cooling airflow at idle conditions. This is accomplished by using a fan diameter where the fan blade diameter circle itself covers the portion of the oil cooler tubes. The fan diameter circle is always included within the fan shroud coverage area.

Aspects of the present invention provide for a method for improving airflow in a heat exchange system having a combo-cooler heat exchanger, a radiator, a fan and a fan shroud associated with the fan; said combo-cooler heat exchanger comprising at least one fluid cooler and a condenser, said method comprising the step of; adapting the fan shroud to cause airflow through said entire condenser and at least a portion of said at least one cooler during idle conditions, while permitting ram airflow through at least a portion of said radiator and at least a portion of said at least one cooler during non-idle conditions. Various aspects of the present invention further provide a method comprising the step of selecting a size of each of said condenser and said radiator using an aspect ratio of said radiator. Other aspects provide for an aspect ratio greater than 1.0:1.0.

These and other objects and advantages of the invention will be apparent from the following description, the accompanying drawings and the appended claims.

### BRIEF DESCRIPTION OF THE DRAWINGS

FIG. 1A is a side view of a prior art heat exchange system;

FIG. 1B is an axial view of the prior art heat exchanger system shown in 1A;

FIG. 2A is a side view of a prior art heat exchange system;

FIG. 2B is an axial view of the prior art heat exchanger system shown in 2A;

FIG. 3A is a side view of a prior art heat exchange system;

FIG. 3B is an axial view of the prior art heat exchanger system shown in 3A;

FIG. 4A is a side view of a prior art heat exchange system;

FIG. 4B is an axial view of the prior art heat exchanger system shown in 4A;

FIG. 5A is a side view of a prior art heat exchange system;

FIG. 5B is an axial view of the prior art heat exchanger system shown in 5A;

FIG. 6A is a side view of one embodiment of the invention;

FIG. 6B is an axial view of the embodiment shown in FIG. 6A;

FIG. 7 is an isometric view of the embodiment shown in FIGS. 6A and 6B;

FIG. 8 is a view showing the heat exchange system of FIG. 6A-7 mounted in a vehicle;

FIGS. 9A-9K illustrate various single fan shroud coverage area examples;

FIGS. 10A-10K illustrate various dual fan shroud coverage area examples; and

FIG. 11 is a graph illustrating a fan shroud minimum coverage area for different heat exchanger aspect ratios assuming condenser coverages fit the percent of the heat exchanger height and fan diameters matches key minimum core face dimension for either single or dual fan configurations.

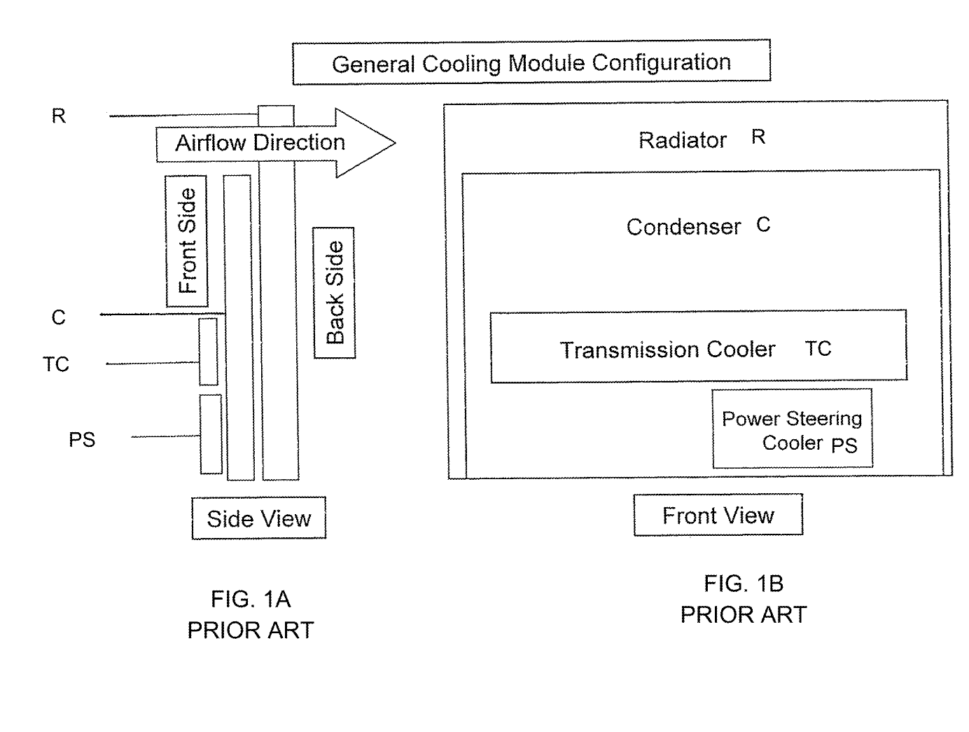

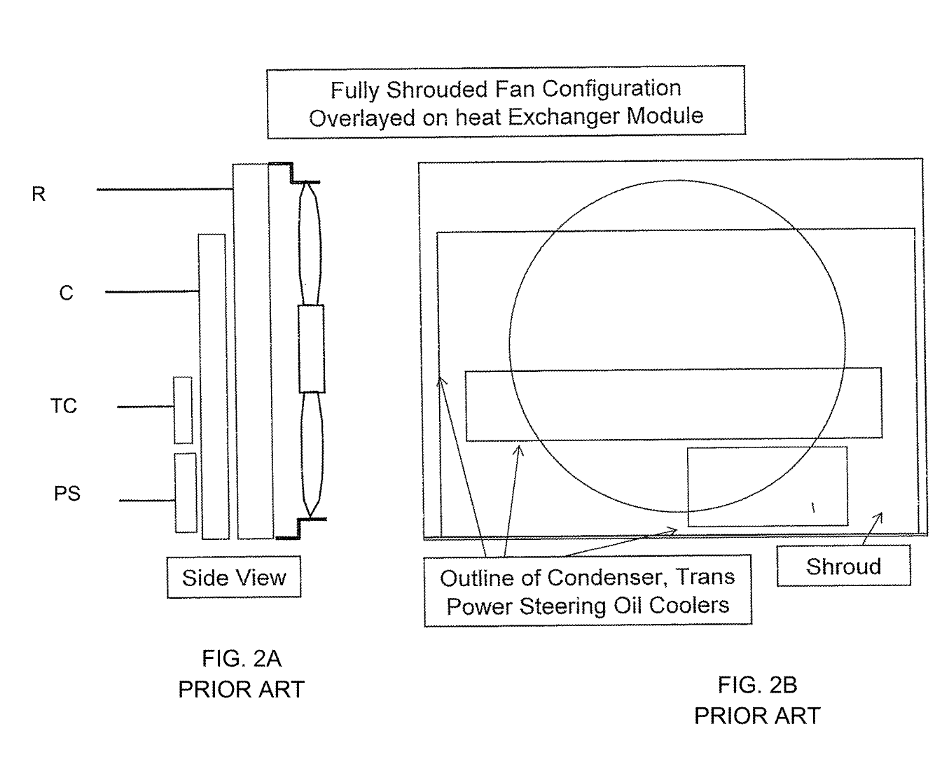

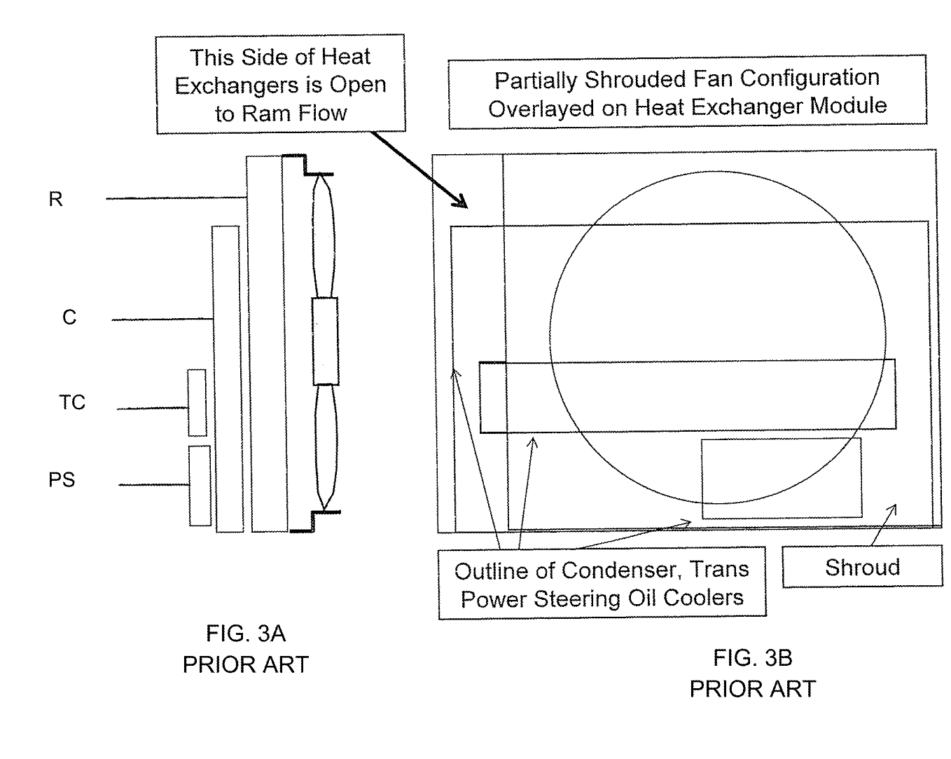

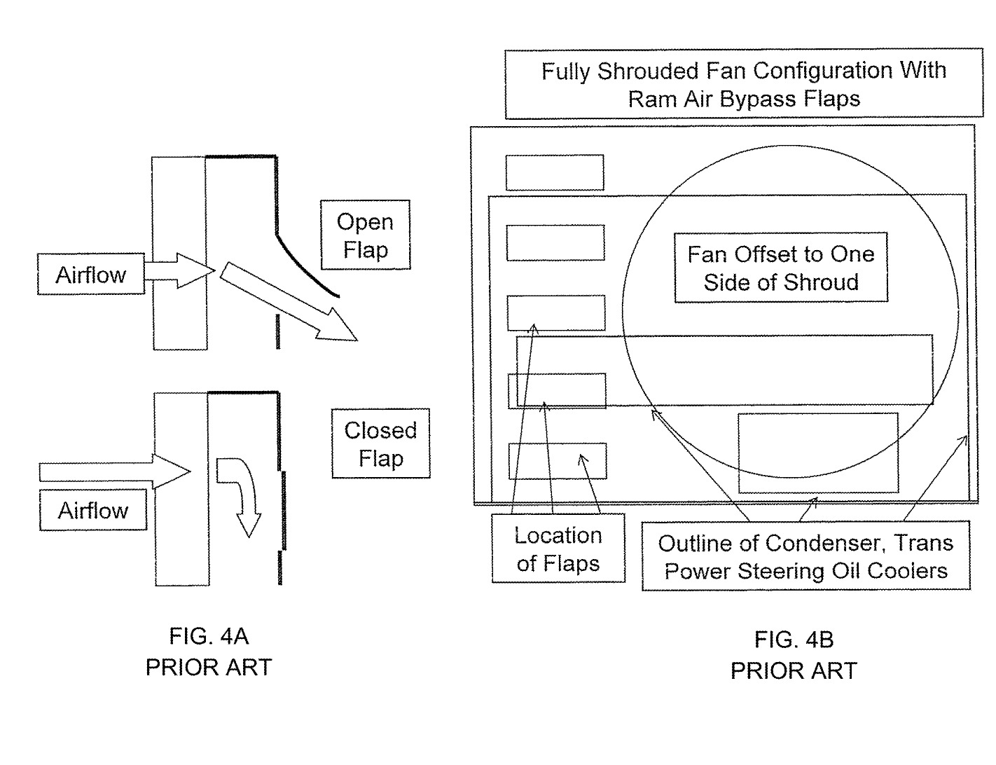

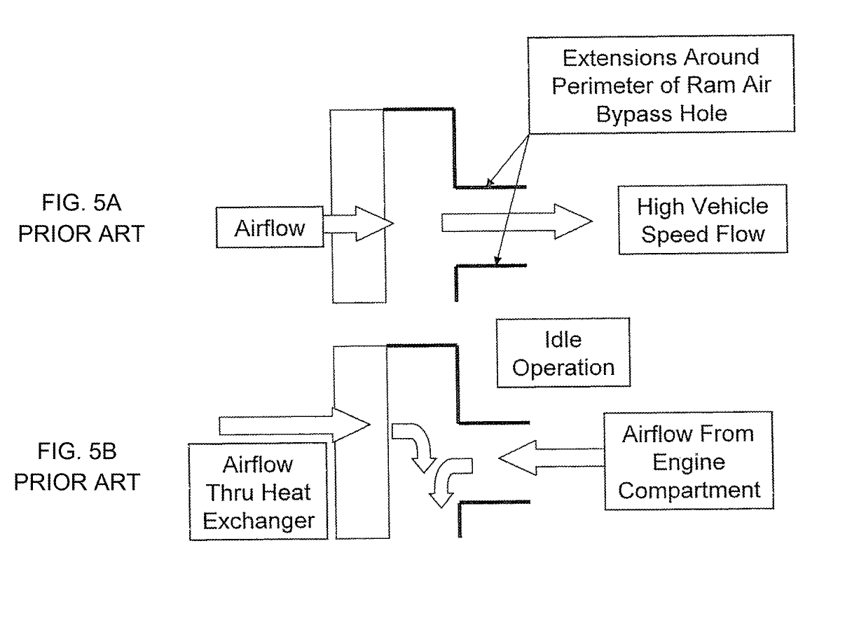

### DETAILED DESCRIPTION OF EMBODIMENTS

In general, various aspects of the present invention provide for a number of advantages. For example, flow through transmission oil cooler is increased during trailer tow grade test point where transmission cooling requirements are at their highest. Trailer tow grade testing usually occurs with vehicle speeds of 55 to 65 MPH. These speeds are typically high enough for ram flow to overcome the flow potential of an electric fan system. Aspects of the present invention allow for improved cooling performance which may allow a reduction of size and cost of the oil cooler portion of the combo cooler.

Total radiator airflow, as described hereinabove, is increased for trailer grade test conditions in aspects of the present invention with cooling fan shroud configurations (for example, a 100% coverage shroud configuration), which is different from a flap, or a ram flow bypass hole design. Aspects of the present invention, therefore, may not only allow reduction of size and cost of the radiator core, but also improve radiator performance for one of its worst case operating conditions.

In various embodiments of the present invention, a ratio of shroud coverage area of shroud to heat exchanger face area increases as an aspect ratio of radiator increases or decreases as an aspect ratio of radiator increases. In a heat exchanger comprising a plurality of fans, a ratio of shroud coverage area of shroud to heat exchanger face area can increase as an aspect ratio of the radiator increases.

In aspects of the present invention, increased radiator airflow occurs in an area with a lower radiator air inlet temperature than is present in other areas that are behind other upstream heat exchanger components. This further increases heat transfer performance of the radiator which may allow for further reduction in size and cost of the component.

Aspects of the present invention also provide for cooling fan shrouds that allow for total airflow through the condenser core at idle to be improved compared to alternate fan system design options. Much more of the fan's airflow at idle is focused on the condenser core face area. This improves condenser airflow compared to various prior art alternatives. Various aspects of the present invention improve condenser airflow at Idle, which is typically the worst case operating condition for the A/C system.

It has also been found that embodiments of the present invention allow for fan operating efficiency improvement. Reduction in fan shroud coverage area shifts the flow versus pressure operating point of the fan into a more efficient operating range. A reduction of fan motor power level or a further increase in airflow is therefore possible to be achieved.

This offers a lower cost option to improve trailer grade airflow while preserving idle airflow through the condenser.

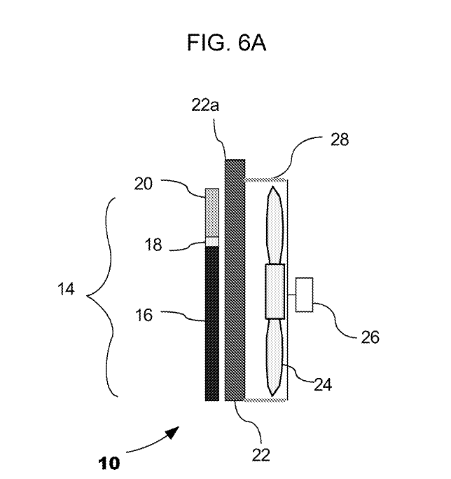

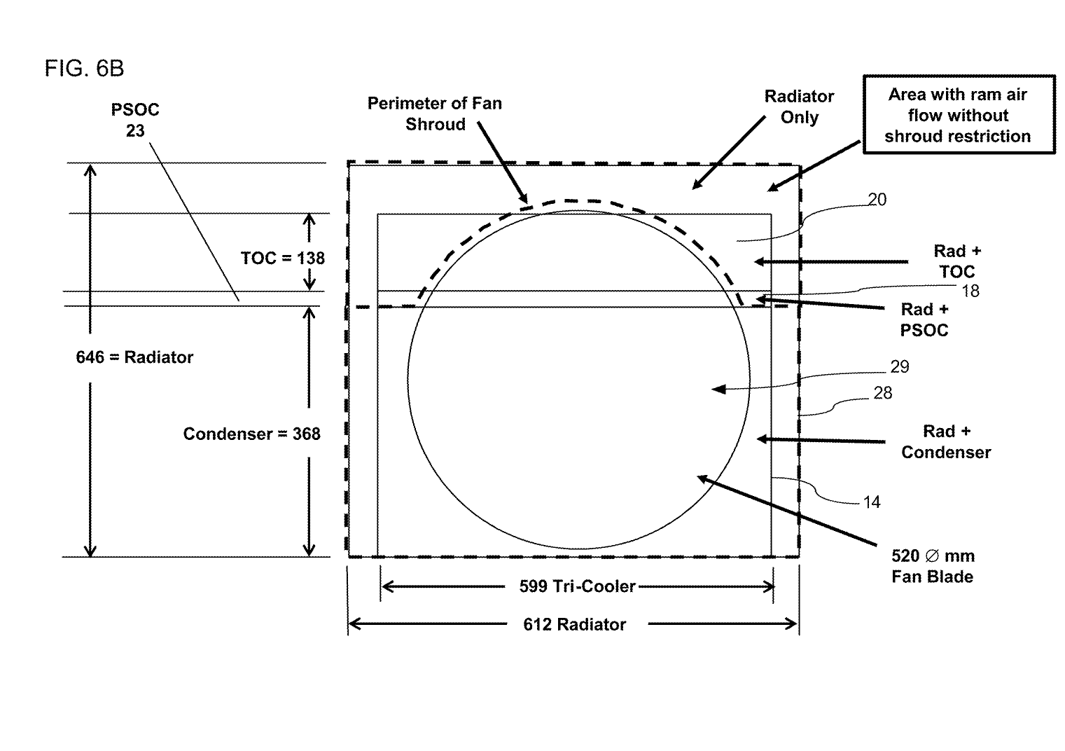

Referring now to FIGS. 6A, 6B, 7 and 8, a cooling system 10 is shown for use in a vehicle 12 (FIG. 8). The system 10 is particularly useful in light truck and small utility vehicle (SUV) market segments where high speed trailer tow requirements may be necessary.

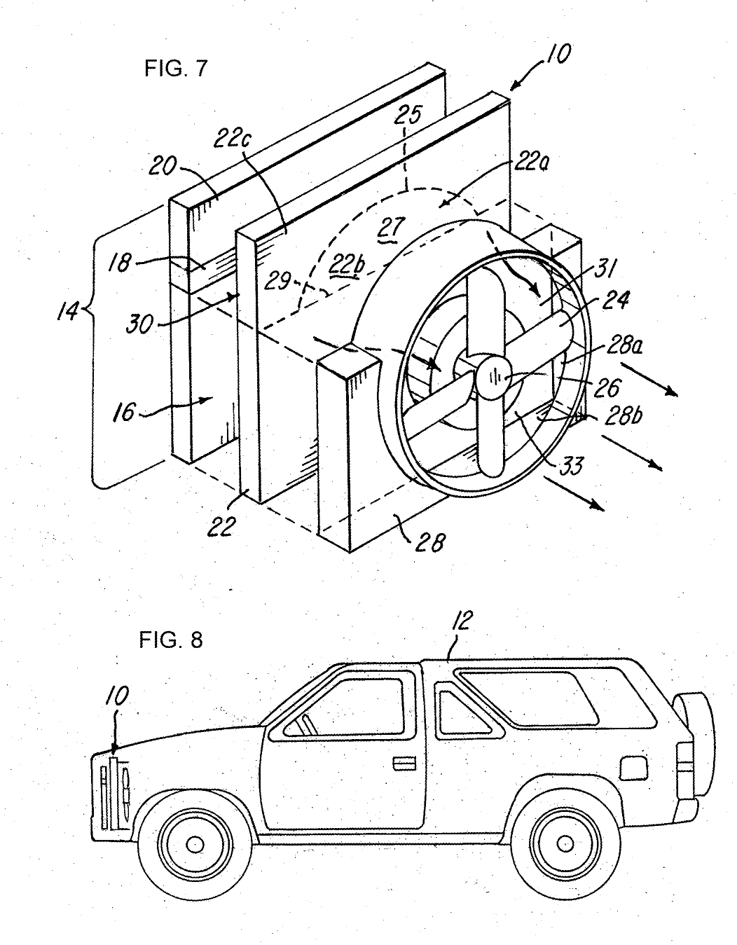

As illustrated in FIGS. 6A, 6B and 7, the system 10 comprises a combo-cooler 14 comprising an air conditioning condenser 16 and at least one oil cooler, such as the power steering oil cooler 18 and transmission oil cooler 20 as shown. In the illustration being described, the combo-cooler heat exchanger 14 is situated upstream of a radiator 22 and fan 24 in a manner that is conventionally known. One suitable combo-cooler heat exchanger 14 is shown and described in U.S. Pat. No. 6,793,012, which is incorporated herein by reference and made a part hereof and is available from Valeo Electrical Systems, Inc. of Auburn Hills, Mich.

The system 10 further comprises at least one fan 24 that is driven by a motor 26, such as an electric motor (not shown), of the type that is conventionally known. A dual or multiple fan configuration (not shown) may also be adjusted for use with the invention. A fan shroud 28 surrounds the fan 24 as shown.

During idle conditions, airflow through the system 10 is generated primarily by the fan 24 which is driven by the electric motor 26. The fan 24 causes air to be pulled through both the air conditioning condenser 16 and at least a portion of a face area of radiator 22. Face 22a represents the total face area of the radiator. Face 22c represents the face of the area that is not covered by the fan shroud and is the curved dashed line 25 and dashed straight line 29. Curved line 25 represents the edge of the fan shroud coverage area. Straight line 29 represents the edge of the condenser core face area. Face 22b is the partial circular area within the shroud coverage area that is between dashed line 29 and curved line 25. Notice that a portion 22c of the face 22a of radiator 22 above the portion 22b (i.e., the portion 22c above dashed line 25) is not covered by the shroud 28. In the illustration being described and as shown in FIGS. 6B and 7, notice that the shroud 28 is adapted to surround the fan 24 and adapted to cover the entire air conditioning condenser 16, as well the entire diameter of the fan 24. Notice that the area 27 (22b) between line 25 and imaginary line 29 is adapted to cause or ensure that at least a portion of the fluid coolers 18 and 20 and the tube or tubes (not shown) and fins (not shown) therein receive at least some cooling.

Thus, it should be understood, that the shroud 28 is adapted and configured to cover one hundred percent or the entire surface area of the air conditioning condenser 16 as well as a fan area 29 defined by the diameter of the blade 24. This feature is advantageous because during idle conditions, airflow is caused to flow across 100 percent of the condenser 28. During non-idle conditions or in conditions where maximum cooling is required to the oil coolers 18 and 20, the shroud 28 is adapted and configured to cause maximum ram flow through the portions of the coolers 18 and 20 that are not overlapped by the portions of the shroud 28 as illustrated in FIGS. 6A and 6B. This enables total airflow through the air conditioning condenser 16 at idle and improved airflow through the oil cooler heat exchangers 18 and 20 and at portion 22c of radiator 22 during higher vehicle operating speed.

It should be understood that while the embodiment illustrated in FIGS. 6A-7 show the shroud 28 covering 100 percent of the condenser 16 of the combo-cooler heat exchanger 14, the shroud 28 may be configured to cover less than 100 percent of the condenser 16 or otherwise be adapted or configured to cover portions of the combo-cooler heat exchanger 14 in response to the cooling needs of the particular application. For example, if less power steering oil cooling is required, then the combo-cooler 14 may be configured such that the power steering oil cooler 18 is adapted or configured to have less of its area “blocked” or unavailable to cooling airflow at idle conditions because the tubing (not shown) used in the power steering oil cooler 18 is in an area that is not covered by the shroud 28.

Thus, it should be understood that during idle conditions airflow through the combo-cooler heat exchanger 14 and the radiator 22 is primarily through the areas that are covered by the shroud 28. The areas of the combo-cooler heat exchanger 14 and radiator 22 that are not covered by the shroud 28 typically will not receive airflow in idle conditions, but will receive ram airflow during non-idle conditions. Thus, the shroud 28 may be adapted and configured to cover those portions of the radiator 22 and combo-cooler heat exchanger 14 as may be necessary given the particular application. By way of example, if more cooling is required during idle conditions for the power steering cooler 18, then the shroud 28 may be adapted and configured to cover more of that area, or alternatively, the combo-cooler 14 may be adapted and configured such that more of the area of the power steering cooler 18 is covered by the shroud 28.

Thus, in one aspect of the invention, it is desired to cover 100 percent of the air conditioning or A/C condenser 16 with the shroud 28. Other variations and configurations, however, of the shroud 28 and the amount of area of coverage of different percentages of the combo-cooler tubing or tubing (not shown) of radiator 22 is simply an optimization to best meet the needs of the application at hand.

Although not shown, the invention may also be used with pusher fan type configurations where the fan 24 and drive motor 26 and shroud 28 are situated upstream of the combo-cooler heat exchanger 14 and radiator 24.

Advantageously, the embodiments described herein permit one or more of the following advantages:
Flow through transmission oil cooler 20 is increased during trailer tow grade test point where transmission cooling requirements are at their highest. Trailer tow grade testing usually occurs with vehicle speeds of 55 to 65 MPH. These speeds are typically high enough for ram flow to overcome the flow potential of an electric fan system. This improves cooling performance which may allow a reduction of size and cost of the oil cooler portion of the combo cooler.
Total radiator 22 airflow is increased for trailer grade test condition with this configuration compared to a 100% coverage shroud configuration, or a flap, or a ram flow bypass hole design. This may allow reduction of size and cost of the radiator core. This also improves radiator performance for one of its worst case operating conditions.
Increased radiator airflow occurs in an area with a lower radiator air inlet temperature than is present in other areas that are behind other upstream heat exchanger components. This further increases heat transfer performance of the radiator which may allow for further reduction in size and cost of the component.
Total airflow through the condenser core at idle will be improved compared to the aforementioned alternate fan system design options. Much more of the fan's airflow at idle is focused on the condenser core face area. This will improve condenser airflow compared to the alternatives. This improves condenser airflow at idle, which is typically the worst case operating condition for the A/C system.
Fan operating efficiency can be improved. Reduction in fan shroud coverage area shifts the flow vs pressure operating point of the fan into what is typically a more efficient operating range. This may allow for a reduction of fan motor power level or a further increase in airflow to be achieved.
This offers a lower cost option to improve trailer grade airflow while preserving idle airflow through the condenser. Lower cost compared to the other options.

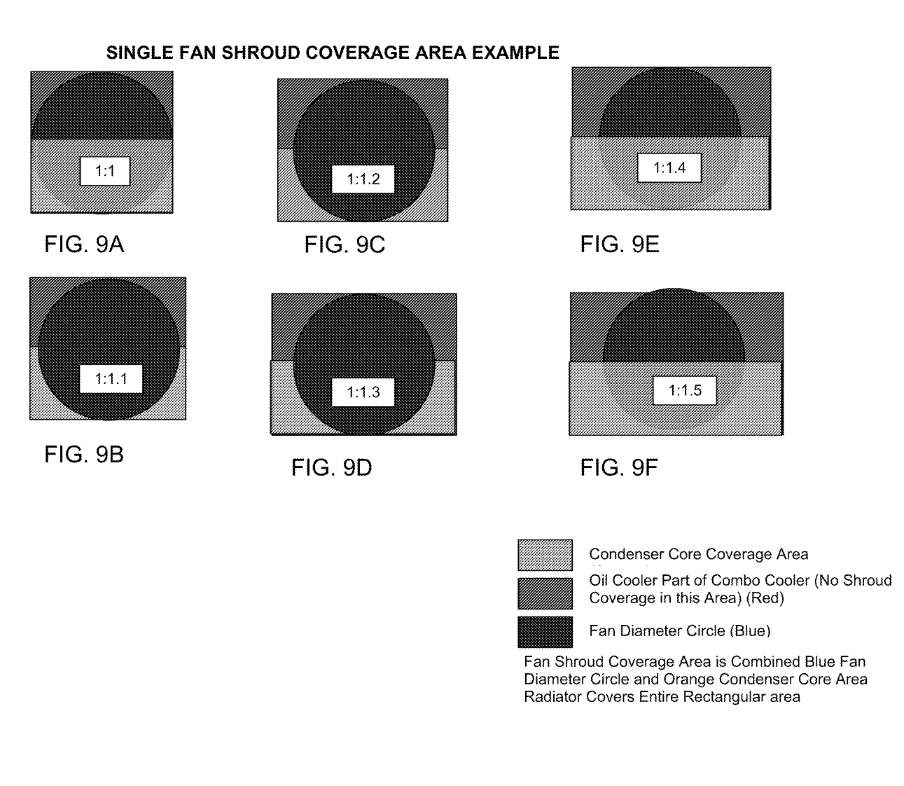

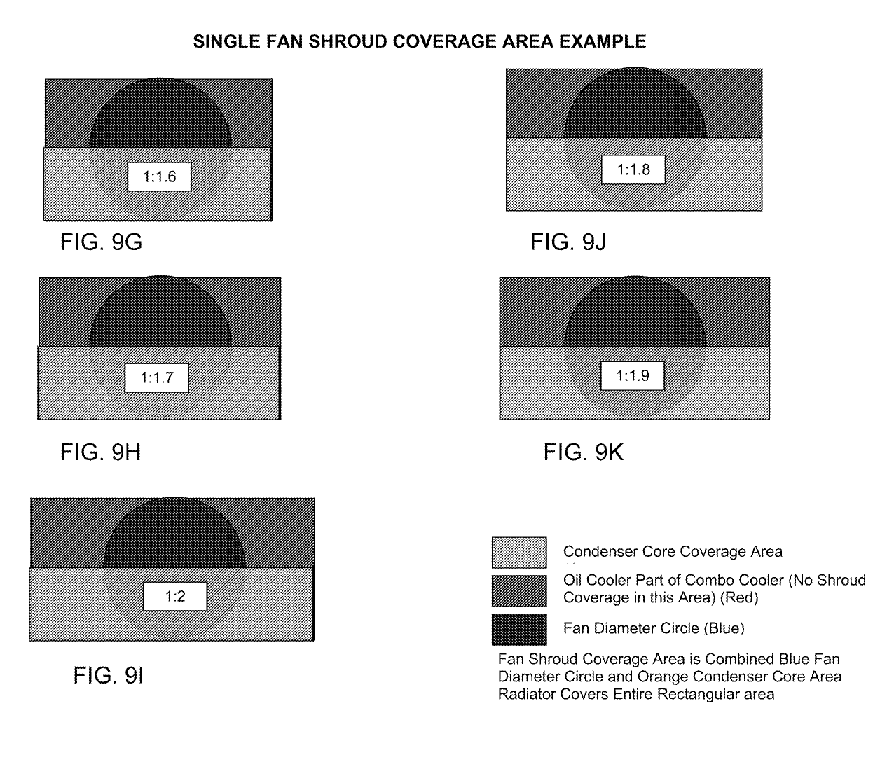

Referring now to FIGS. 9-11, it should be understood that a maximum percentage of shroud 28 coverage area for the combo-cooler heat exchanger 28 depends on multiple factors, including the various sizes of the components 16,18 and 20 of the combo-cooler heat exchanger 14 and the tubes therein. Typical tube pitch, or the difference in the height-dimension between adjacent tubes within each of the condenser 16 and oil cooler heat exchangers 20, ranges from 9-12 millimeters. Maximum height radiator core face dimension for some vehicles, such as super duty diesel light trucks, may be in the 700 millimeter range. Smallest radiator core height for passenger vehicles can be as small as 350 millimeters. The smallest height oil cooler portion 18 of a combo-cooler heat exchanger 14 would use only one internal cooling tube (not shown). This would require a core height of about 9-12 millimeters. Given a 9-12 millimeter oil cooler 18 height with a 700 millimeter height radiator core would give a 100 percent condenser core face area coverage fan shroud area 28 percentage of about 98.7 percent.

In contrast, the same 9 millimeter oil cooler tube height used with a 350 millimeter radiator core would represent a fan shroud coverage area percentage area of about 97.4 percent. The upper portion of the fan diameter circle for either a single or dual fan configuration would increase this coverage percentage somewhat so a maximum shroud coverage rate of 99 percent for both single or dual fan configurations may be desirable or assumed for most applications.

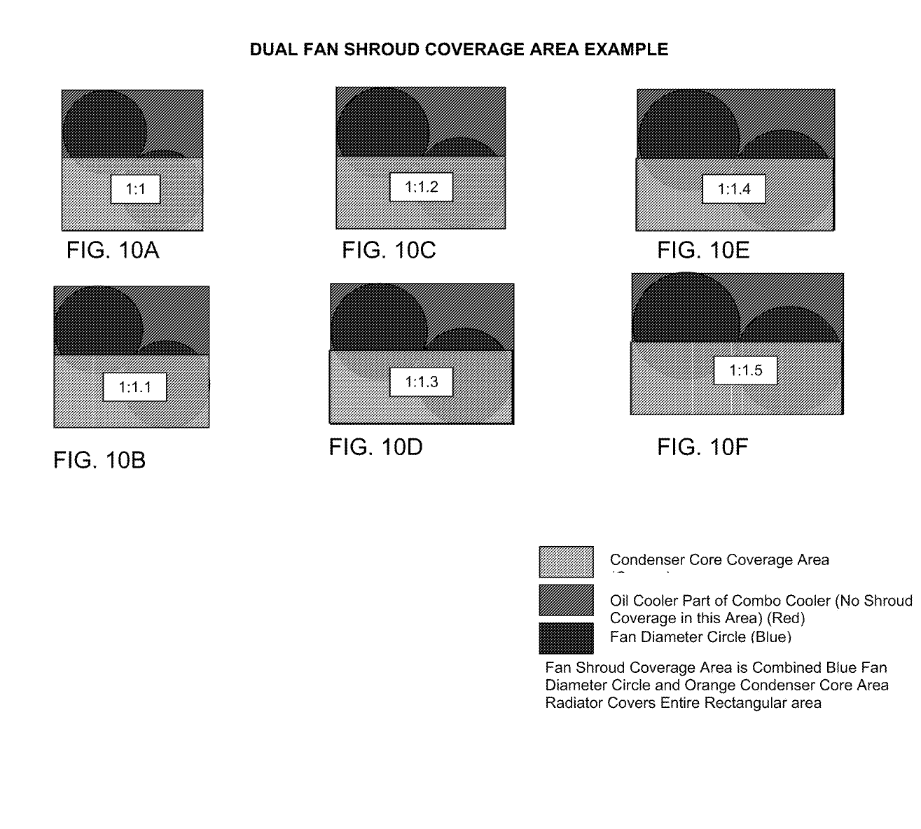

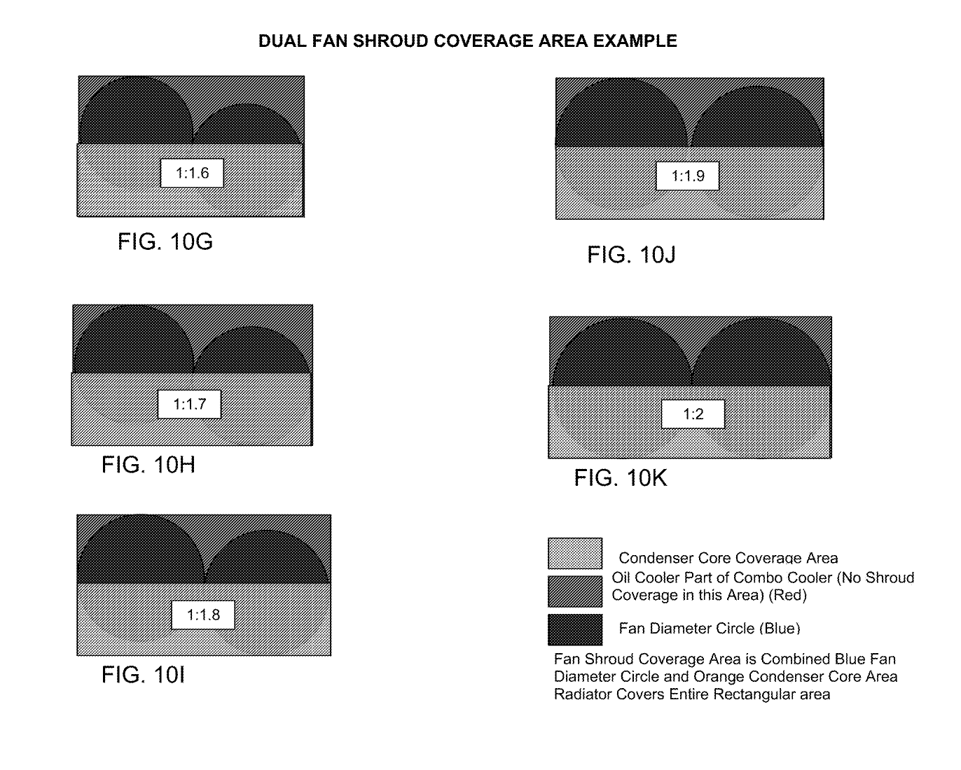

FIGS. 9A-9K illustrate a single fan shroud coverage area and show the aspect ratio of the radiator 22 relative to the condenser 16 and oil coolers 18 and 20. FIGS. 10A-10K illustrate dual fan coverage areas and show aspect ratios of the radiator 22 relative to the condenser 16 and coolers 18 and 20.

An illustration of a method and system for selection of the fan shroud 28 coverage area will now be described. The coverage area of the shroud 28 is usually established by the extent of the radiator 22 core face area. The area of the radiator 22 typically occupies the largest height and width opening in the front of the vehicle. The core face of the combo-cooler heat exchanger 14 typically occupies a width or lateral dimension similar to that of the radiator width dimension, although it can be smaller or larger depending on the application. An assumption for the illustration being described assumes that the combo-cooler heat exchanger 14 comprises a width that matches or is substantially the same as a width of the radiator 22.

Configurations where the combo-cooler heat exchanger 14 may have a smaller width than the radiator 22 do not impact the fan shroud coverage area considerations when using the radiator 22 having a face area 22a on which to base the percentage calculation. One factor here is the assumed height of the AC condenser 16 portion of the combo-cooler heat exchanger 14, which is assumed to be less than the face area 22a of the radiator 22. For ease of discussion, the radiator 22 has the overall face area 22a (FIG. 10) comprising the area 22b that is covered by the shroud 28 and the area 22c that is not covered by the shroud 28. As mentioned earlier herein, the area 22c is subject to ram flow during non-idle conditions, but is subject to little or no flow during idle conditions.

In general, cooling fan design practice typically matches a diameter of the fan 24 to either a height or width of the radiator 22 face area 22a. Single fan systems, of the type diagrammatically illustrated in FIG. 9, match a fan diameter to the smaller of either the height or width. A dual fan system of the type diagrammatically illustrated in FIG. 10, provides fans having fan diameters that are based on the diameter stack to best fit two circles and rectangular area given by the core face area 22a. Although not shown, systems may be designed where the diameter area of the fan 24 overlaps the rectangular area 22a defined by the face of the radiator 22. An overlapped condition will not significantly impact the issue of the shroud open area percentage range.

In the illustration being described, the combo-cooler heat exchanger 14 configuration assumes that the condenser 16 portion of the face area of the combo-cooler 14 occupies the lower portion of the combo-cooler heat exchanger 14, while the upper portion (portions 18 and 20) of the combo-cooler heat exchanger 14 is used for power steering oil cooling, transmission oil cooling and/or engine oil cooling. It should be understood, however, that principles of the invention may be used with combo-cooler heat exchangers 14 that are configured with condenser portions 16 on either the top or bottom of the combo-cooler heat exchanger 14.

Another assumption for the illustration being described is that the condenser core 16 usually does not extend beyond 50 percent of a height of the overall face area of the combo-cooler heat exchanger 14. The total face area for the condenser 16 is driven by the amount of condenser heat rejection required by the typical vehicle, whether it be a passenger car, light truck or heavy truck application, and the heat exchange performance of the specific condenser core 16 and the tube or tubes (not shown) and fins (not shown) being used within the condenser 16. In general, the smallest face area of a combo-cooler heat exchanger 14 that would be devoted to the condenser 16 function is thought to be close to a 50 percent value in the illustration. This takes all the above factors into consideration. Vehicles 12 with large radiator and cooler heat exchanger requirements with relatively small passenger cabins may allow use of a configuration with a condenser 16 to total heat exchange face area of the combo-cooler heat exchanger 14 to be less than 50 percent. Such vehicles would not be considered to be mainstream vehicles.

The diagrams compare the diameter of the fan 24 and shroud 28 coverage area for single (FIG. 9) and dual (FIG. 10) fan systems for different rectangular heat exchanger 22 aspect ratios. This allows a visualization of how the shroud coverage or open oil cooler area varies with a change in an aspect ratio of the radiator 22. Various assumptions for these examples are as follows:
A fan 24 diameter circle does not overlap or extend beyond the radiator 22 core face 22a.
The condenser 16 portion of the combo-cooler 14 covers 50 percent of a height of the face area 22a of the radiator 22.
The portion of the combo-cooler heat exchanger 14 area that is dedicated to oil cooling or oil cooler 18 and transmission oil cooler 20 that extends beyond the fan 24 diameter and that is not covered by the shroud 28 is left open to ram flow alone.

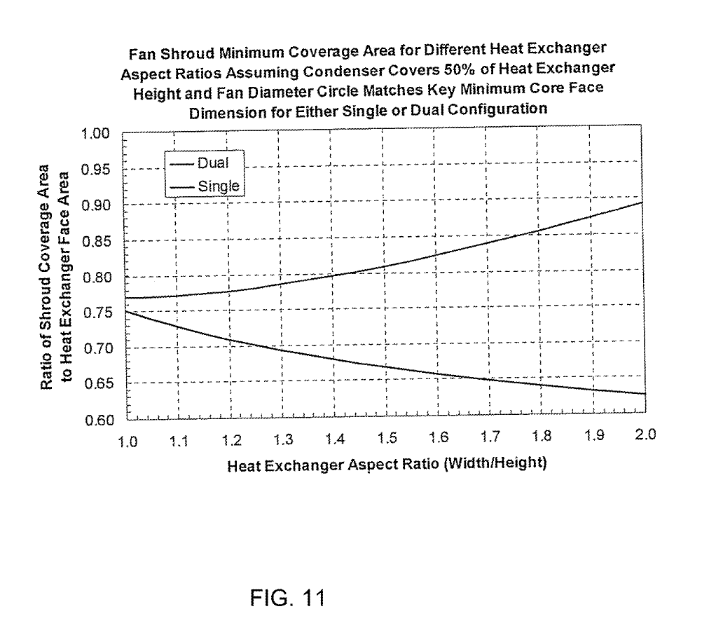

FIG. 11 graphically illustrates a relationship between the minimum shroud 28 coverage area and a rectangular aspect ratio for the core face 22a of the radiator 22 for single (FIG. 9) and dual (FIG. 10) fans. These are considered minimum values. FIG. 11 shows fan shroud 28 minimum coverage area for different heat exchanger aspect ratios assuming the condenser covers 50 percent of the heat exchanger or radiator 22 height and a diameter of the fan 24 matches the smaller of the minimum width or height of the face 22a of the radiator 22 for either single or dual fan configuration.

Interestingly, notice that for a dual fan configuration, the ratio of the shroud 28 coverage area to the radiator face area 22a generally increases as the aspect ratio (width to height) of the radiator 22 increases. In contrast, for a single fan arrangement of the type shown in FIG. 9, the ratio of the shroud 28 coverage area to heat exchanger face area 22a generally decreases as the aspect ratio increases. It should be understood that the area above the dual fan curve and the single fan curve generally defines an open area or the portion of the face area 22a that is not covered by the shroud 28 and that, therefore, is subject to ram air at non-idle conditions. In the illustration shown in FIG. 7, this area would correspond to the area 22c illustrated in FIG. 7. Of course, those positions of the coolers 19 and 20 that are situated above shroud 28 are also exposed to ram air. Note that the area 31 defined by an interior wall 28a is in fluid communication with an area 33 defined by the wall 28b.

Advantageously, this system and method provides means and apparatus for providing a combination of a heat exchanger 22 with a combo-cooler heat exchanger 14 and fan shroud 28 where the fan shroud 28 covers substantially all or one hundred percent of the condenser portion 16 of the combo-cooler heat exchanger 14 and leaves portions of the oil coolers 18 and 20 exposed or open to RAM airflow.

At least one preferred embodiment is shown in FIGS. 6A-6B, 7 and 8. It should be clear that various aspects of the present invention can lead to optimization or optimized designs that depend on various factors and can be achieved by varying the amount of fan shroud coverage area/ram airflow bypass area of the oil cooler tube portions of the combo cooler, depending on the specific needs of the automotive application. For example, the oil cooler portion 18,20 of the combo-cooler heat exchanger 14, in various aspects of the present invention, can be located on the bottom of the combo-cooler heat exchanger 14 as it relates to the overall module, as opposed to the top portion of the combo-cooler heat exchanger 14 as shown in the figures above. In various aspects of the present invention, the cooling fan shroud covers near to or equal to about 100% of the condenser 28 tubes of the combo-cooler heat exchanger 14. As described above, other variations of fan shroud coverage of different percentages of the combo oil cooler tubes or radiator tubes can also be done to optimization to best meet the needs of the desired application. In other aspects of the present invention, cooling fans arranged in a blow versus pull fashion (“pusher” type fan configurations) are employed where the fan or fan system is on the front or inlet side of the combo-cooler heat exchanger 14.

While the form of apparatus herein described constitutes a preferred embodiment of this invention, it is to be understood that the invention is not limited to this precise form of apparatus, and that changes may be made therein without departing from the scope of the invention which is defined in the appended claims.

What is claimed is:

1. A heat exchanger assembly comprising a heat exchanger module with a combo cooler and a cooling fan shroud wherein the cooling fan shroud covers substantially all of a condenser portion of said combo cooler.

2. A heat exchanger as in claim 1, wherein at least one set of tubes of the combo cooler is comprised of oil cooler tubes.

3. A heat exchanger as in claim 2, wherein at least part of the oil cooler tubes is open or available to be subjected to ram flow.

4. A heat exchanger assembly comprising:
a combo-cooler heat exchanger comprising a condenser and at least one cooler; and
a fan shroud substantially covering said condenser, while leaving uncovered at least a portion of said at least one cooler.

5. The heat exchanger assembly as recited in claim 4 wherein said at least one cooler comprises:
a power steering oil cooler; and
a transmission oil cooler;
said fan shroud being adapted to permit ram airflow directly to at least a portion of each of said power steering oil cooler and said transmission oil cooler while substantially covering said condenser portion of said combo-cooler heat exchanger to permit airflow to said condenser during idle conditions.

6. The heat exchanger as recited in claim 4 wherein said heat exchanger assembly further comprises:
a radiator,
said condenser of said combo-cooler heat exchanger covering at least fifty percent of said radiator and said radiator covering substantially all of said condenser.

7. The heat exchanger as recited in claim 6 wherein a ratio of shroud coverage area of said shroud to heat exchanger face area is less than 75% for a radiator having an aspect ratio of 1:1.0 or higher.

8. The heat exchanger as recited in claim 6 wherein said heat exchanger comprises a plurality of fans, a ratio of fan shroud coverage area of said shroud to heat exchanger face area is at least 77% for a radiator having an aspect ratio of 1:1.0 or higher.

9. A heat exchange assembly for use in a vehicle comprising:
a radiator;
a combo-cooler comprising a condenser having condenser tubing and at least one fluid cooler having fluid cooler tubing;
a fan;
a drive motor for driving said fan; and
a shroud having a wall surrounding said fan;
said shroud being adapted to cover substantially all of said condenser to permit airflow to said condenser during an idle condition, yet permitting ram airflow through at least a cooler portion of said at least one fluid cooler during non-idle conditions.

10. The heat exchange assembly as recited in claim 9 wherein said shroud is also adapted to permit ram airflow through at least a portion of said radiator.

11. The heat exchange assembly as recited in claim 9 wherein said at least one fluid cooler comprises:
a power steering oil cooler; and
a transmission oil cooler;
said fan shroud being adapted to permit ram airflow directly to at least a portion of each of said power steering oil cooler and said transmission oil cooler while substantially covering said condenser portion of said combo-cooler heat exchanger.

12. The heat exchange assembly as recited in claim 9 wherein said heat exchange assembly further comprises:
a radiator,
said condenser of said combo-cooler heat exchange assembly covering at least fifty percent of said radiator and said radiator covering substantially all of said condenser.

13. The heat exchange assembly as recited in claim 9 wherein a ratio of shroud coverage area of said shroud to heat exchange assembly face area is less than 75% for a radiator having an aspect ratio of 1:1.0 or higher.

14. The heat exchange assembly as recited in claim 9 wherein said heat exchange assembly comprises a plurality of fans, a ratio of shroud coverage area of said shroud to heat exchange assembly face area is at least 77% for a radiator having an aspect ratio of 1:1.0 or higher.

15. The heat exchange assembly as recited in claim 9 wherein said heat exchange assembly is mounted in a vehicle, said shroud and fan mounted in said vehicle downstream of said combo-cooler heat exchanger.

16. The heat exchange assembly as recited in claim 9 wherein said heat exchange assembly is mounted in a vehicle such that said shroud and fan are mounted in said vehicle upstream of said combo-cooler heat exchanger.

17. A method for enabling airflow through a condenser of a combo-cooler heat exchanger during idle conditions, while enabling ram airflow to at least one fluid cooler of said combo-cooler heat exchanger during non-idle conditions, said method comprising the steps of:
determining a cooling need for said condenser and at least one cooler in said combo-cooler;
selecting a condenser size of said condenser to cover at least fifty percent of said radiator;
selecting a radiator size of said radiator to cover substantially all of said condenser;
adapting a shroud so that substantially all of said condenser is within an idle airflow area defined by at least one wall of said shroud; and
arranging said shroud, radiator and combo-cooler heat exchanger so that the condenser substantially within said idle airflow.

18. The method as recited in claim 17 wherein said method further comprises the step of:
arranging said at least one fluid cooler and said condenser within said combo-cooler heat exchanger and relative to said shroud so that at least a portion of said at least one fluid cooler is exposed to ram airflow during non-idle conditions and substantially all of said condenser is subject to airflow during idle conditions.

19. The method as recited in claim 17 wherein said method further comprises the steps of:
determining a radiator cooling requirement and a fluid cooler cooling requirement for said at least one fluid cooler;
adapting a shape of said shroud to cover all of said condenser while covering less than all of said at least one fluid cooler in response to said determining step.

20. The method as recited in claim 17 wherein said shroud covers all of said condenser and is adapted to permit ram airflow through at least a portion of both radiator and said at least one fluid cooler.

21. The method as recited in claim 17 wherein said at least one fluid cooler comprising a power steering oil cooler and a transmission oil cooler, method further comprises the step of:
adapting said fan shroud to permit airflow directly to a portion of each of said power steering oil cooler and said transmission oil cooler during said idle condition while substantially covering said condenser portion of said combo-cooler heat exchanger to permit one hundred percent airflow through said condenser during non-idle conditions.

22. The method as recited in claim 17 wherein said method further comprises the step of:
adapting said condenser of said combo-cooler heat exchanger to cover at least fifty percent of said radiator; and
adapting each of said radiator and said shroud to cover substantially all of said condenser.

23. The method as recited in claim 17 wherein said adapting step further comprises the step of:
using a ratio of shroud coverage area of said shroud to a radiator face area of said radiator that increases as an aspect ratio of said radiator increases to adapt or configure at least one of said radiator, said shroud or said condenser.

24. The method as recited in claim 17 wherein said adapting step further comprises the step of:
using a ratio of shroud coverage area of said shroud to heat exchange assembly face area that decreases as an aspect ratio of said radiator increases to adapt at least one of said radiator, said shroud or said condenser.

25. The method as recited in claim 17 wherein said fan comprises a plurality of fans, said method comprising the step of:
using a function or ratio of shroud coverage area of said shroud to heat exchange assembly face area that increases as an aspect ratio of said radiator increases to adapt at least one of said radiator or said condenser.

26. The method as recited in claim 17 wherein said method further comprises the step of:
using a function or ratio of shroud coverage area of said shroud to heat exchange assembly face area that is less than 75% for a radiator having an aspect ratio of 1:1.0 or higher to adapt at least one of said radiator or said condenser.

27. The method as recited in claim 17 wherein said method further comprises the steps of:
providing a plurality of fans;
adapting a function or ratio of shroud coverage area of said shroud to heat exchange assembly face area of said radiator to be at least 77% for a radiator having an aspect ratio of 1:1.0 or higher to adapt at least one of said radiator or said condenser.

28. The method as recited in claim 17 wherein said method further comprises the step of:
situating said shroud and fan downstream of said combo-cooler heat exchanger.

29. The method as recited in claim 17 wherein said method further comprises the step of:
situating said shroud and fan are upstream of said combo-cooler heat exchanger.

30. A method for improving airflow in a heat exchange system having a combo-cooler heat exchanger, a radiator, a fan and a fan shroud associated with the fan; said combo-cooler heat exchanger comprising at least one fluid cooler and a condenser, said method comprising the step of;
adapting the fan shroud to cause airflow through said entire condenser and at least a portion of said at least one cooler during idle conditions, while permitting ram airflow through at least a portion of said radiator and at least a portion of said at least one cooler during non-idle conditions.

31. The method as recited in claim 30 wherein said method further comprises the step of:
selecting a size of each of said condenser and said radiator using an aspect ratio of said radiator.

32. The method as recited in claim 30, wherein said ration is greater than 1.0:1.0.
